(19) United States
(12) Patent Application Publication
(10) Pub. No.: US 2007/0016592 A1
(43) Pub. Date: Jan. 18, 2007

(54) Enabling real time decoration for customized topology displays

(75) Inventors: Jeffrey Ferla, Raleigh, NC (US); Paul Franklin McMahan, Apex, NC (US); Richard Brian Southard, Clayton, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/179,255

(22) Filed: Jul. 12, 2005

(51) Int. Cl. G06F 7/00

(52) U.S. Cl. 707/100

(57) ABSTRACT

An application for enabling real-time decoration of graphical topological displays is provided. The application loads a document. The document contains the layout data for the graphical topological display and at least one keyword. The application retrieves data associated with each keyword included in the document. Once the application has received the data, the application renders the graphical topological display, as defined by the document, populated with real-time data.

### BACKGROUND OF THE INVENTION

1. Field of the Invention

The invention relates to data processing systems. In particular, the invention relates to a method, system and computer program product for enabling real time decoration for customized topology displays.

2. Description of the Related Art

The Internet, also referred to as an “internetwork,” is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies that must interact with virtually all segments of society, such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web.” Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML).

In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page,” is identified by a URL. The URL provides a universal, consistent method for finding and accessing this information, not necessarily for the user, but mostly for the user's Web “browser.” A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The Internet has revolutionized communications and commerce, as well as being a source of both information and entertainment. For many users, email is a widely used format to communicate over the Internet. Additionally, the Internet is also used for real-time voice conversations.

The Internet also is widely used to transfer applications to users of Web browsers. With respect to commerce on the Web, individual consumers and businesses use the Web to purchase various goods and services. In offering goods and services, some companies offer goods and services solely on the Web, while others use the Web to extend their reach.

Modern systems management applications typically provide a graphical topology display for monitoring the state of managed resources. A topology shows the arrangement in which the nodes of a network are connected to each other. A graphical topological display may also be any graphical depiction of geometric configurations. The contents and arrangements of those topology displays are limited to the product designer's preconceptions. The end user cannot create her own customized graphical view and then let the application retrieve the underlying data at run-time. If an end user wants a customized display, then the end user must possess advanced database and graphical programming skills to create the customized display.

### BRIEF SUMMARY OF THE INVENTION

The present invention provides a method, system, and computer program product for enabling real-time decoration of graphical topological displays. A document is loaded, wherein the document includes layout information for a graphical topological display and wherein the document includes one or more keywords. Data associated with each keyword included in the document is retrieved. Responsive to receiving the data associated with each keyword included in the document, the graphical topological display, as defined by the document, is rendered, populated with real-time data.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which exemplary aspects of the present invention may be implemented;

FIG. 2 is a block diagram of a data processing system that may be implemented as a server, in accordance with illustrative embodiments of the present invention;

FIG. 3 is a block diagram of a data processing system in which exemplary aspects of the present invention may be implemented;

FIG. 4 is a block diagram of a typical software architecture for a server-client system in accordance with an exemplary embodiment of the present invention;

FIG. 5 is a block diagram of a browser program in accordance with an exemplary embodiment of the present invention;

FIG. 6 is an example of a graphical topological display in accordance with an exemplary embodiment of the present invention;

FIG. 7 is an example of a graphical topological display populated with real-time data in accordance with an exemplary embodiment of the present invention;

FIG. 8 is a block diagram illustrating a system for enabling real-time decoration for customized topology displays in accordance with an exemplary embodiment of the present invention;

FIG. 9 is a block diagram illustrating a system for enabling real-time decoration for customized topology displays in accordance with an exemplary embodiment of the present invention; and

FIG. 10 is a flowchart illustrating the real-time decoration of a customized graphical topological display in accordance with an exemplary embodiment of the present invention.

### DETAILED DESCRIPTION OF THE INVENTION

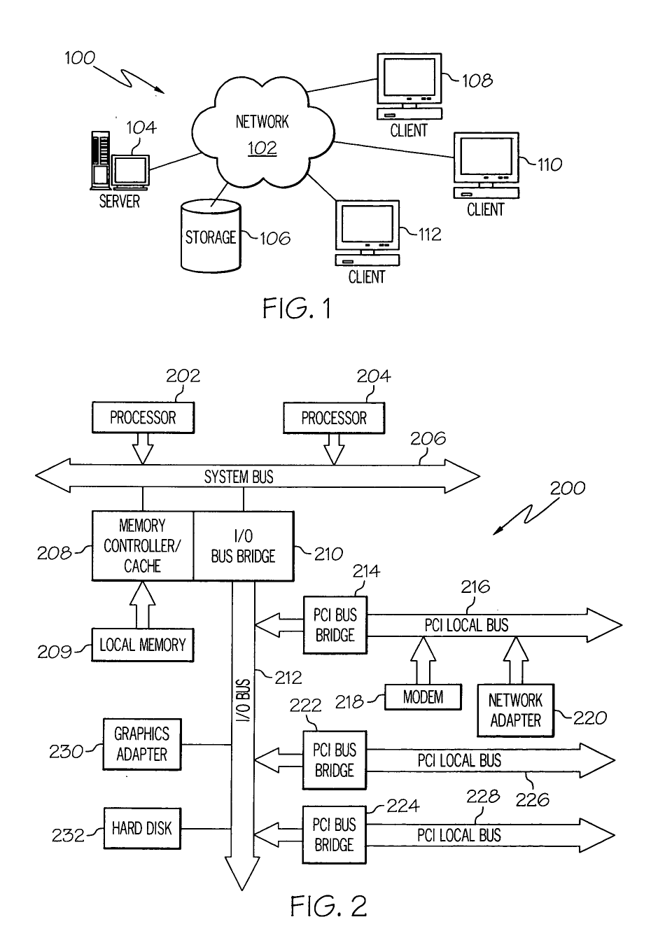

FIGS. 1-3 are provided as exemplary diagrams of data processing environments in which exemplary aspects of the present invention may be implemented. It should be appreciated that FIGS. 1-3 are only exemplary and are not intended to assert or imply any limitation with regard to the environments in which the present invention may be implemented. Many modifications to the depicted environments may be made without departing from the spirit and scope of the present invention.

With reference now to the figures, FIG. 1 depicts a pictorial representation of a network of data processing systems in which exemplary aspects of the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 connects to network 102 along with storage unit 106. In addition, clients 108, 110, and 112 connect to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with an illustrative embodiment of the present invention. Data processing system 200 may be a symmetric multiprocessor (SMP) system including a plurality of processors 202 and 204 that connect to system bus 206. Alternatively, a single processor system may be employed. Also connected to system bus 206 is memory controller/cache 208, which provides an interface to local memory 209. I/O bus bridge 210 connects to system bus 206 and provides an interface to I/O bus 212. Memory controller/cache 208 and I/O bus bridge 210 may be integrated as depicted.

Peripheral component interconnect (PCI) bus bridge 214 connects to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both, while Linux is a trademark of Linus Torvalds in the United States, other countries, or both).

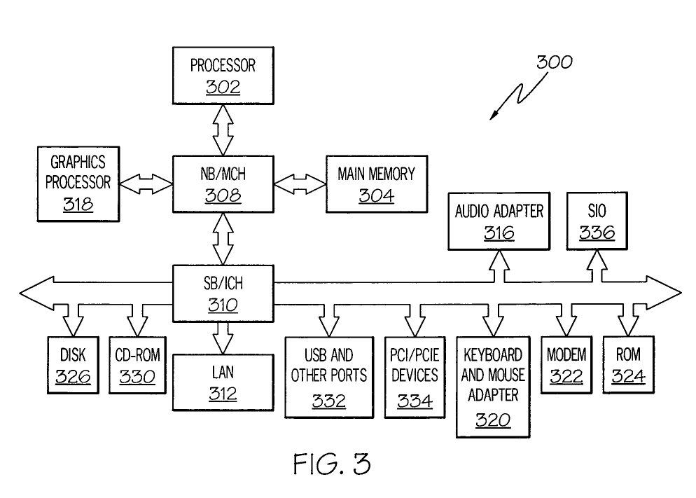

With reference now to FIG. 3, a block diagram of a data processing system is shown in which exemplary aspects of the present invention may be implemented. Data processing system 300 is an example of a computer, such as client 108 in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 connect to ICH 310. PCI/PCIe devices may include, for example, Ethernet adapters, add-in cards, PC cards for notebook computers, etc. PCI uses a card bus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and coordinates and provides control of various components within data processing system 300 in FIG. 3. The operating system may be a commercially available operating system such as the Microsoft® Windows® XP operating system (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 300 (Java is a trademark of Sun Microsystems, Inc. in the United States, other countries, or both).

Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIGS. 1-3 may vary depending on the implementation. Other internal hardware or peripheral devices, such as flash memory, equivalent non-volatile memory, or optical disk drives and the like, may be used in addition to or in place of the hardware depicted in FIGS. 1-3. Also, the processes of the present invention may be applied to a multiprocessor data processing system. As some illustrative examples, data processing system 300 may be a personal digital assistant (PDA), which is configured with flash memory to provide non-volatile memory for storing operating system files and/or user-generated data.

A bus system may be comprised of one or more buses, such as system bus 206, I/O bus 212 and PCI buses 216, 226 and 228 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 218 or network adapter 220 of FIG. 2 or modem 322 or LAN 312 of FIG. 3. A memory may be, for example, local memory 209 or cache such as that found in memory controller/cache 208 of FIG. 2 or main memory 304 of FIG. 3. A processing unit may include one or more processors or central processing units, such as processor 202 or processor 204 of FIG. 2 or processor 302 of FIG. 3. The depicted examples in FIGS. 1-3 and above-described examples are not meant to imply architectural limitations. For example, data processing system 300 also may be a tablet computer, laptop computer, or telephone device in addition to taking the form of a PDA.

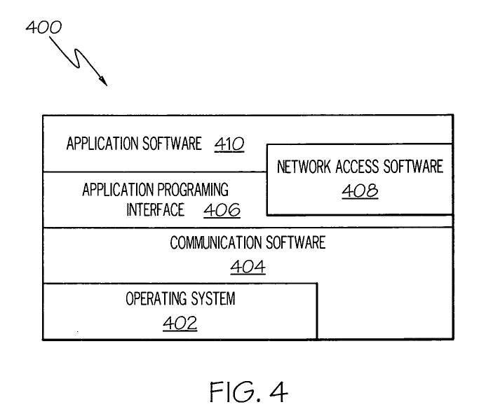

Turning to FIG. 4, typical software architecture for a server-client system, such as system 100 in FIG. 1, is depicted in accordance with an exemplary embodiment of the present invention. At the lowest level, operating system 402 is utilized to provide high-level functionality to the user and to other software. Communication software 404 provides communications through an external port to a network, such as the Internet, via a physical communications link by either directly invoking operating system functionality or indirectly bypassing the operating system to access the hardware for communications over the network.

Application programming interface (API) 406 allows the user of the system, such as an individual, or a software routine, to invoke system capabilities using a standard consistent interface without concern for how the particular functionality is implemented. Network access software 408 represents any software available for allowing the system to access a network. This access may be to a network, such as a local area network (LAN), wide area network (WAN), or the Internet. With the Internet, this software may include programs, such as Web browsers.

Application software 410 represents any number of software applications designed to react to data through the communications port to provide the desired functionality the user seeks. Applications at this level may include those necessary to handle data, video, graphics, photos or text, which can be accessed by users of the Internet. The mechanism of the present invention may be implemented within communications software 404 in these examples.

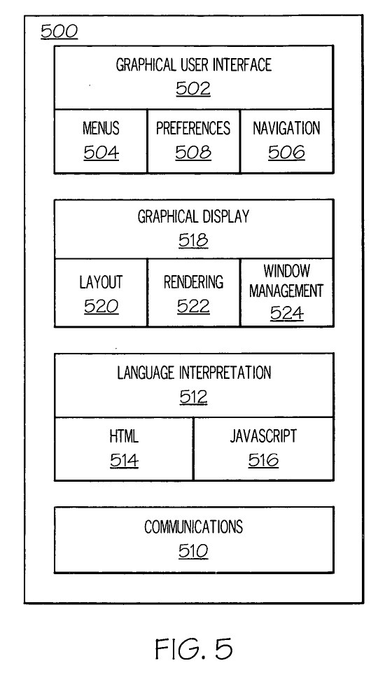

Turning next to FIG. 5, a block diagram of a browser program is depicted in accordance with an exemplary embodiment of the present invention. A browser is an application used to navigate or view information or data in a distributed database, such as the Internet or the World Wide Web.

In this example, browser 500 includes a user interface 502, which is a graphical user interface (GUI) that allows the user to interface or communicate with browser 500. This interface provides for selection of various functions through menus 504 and allows for navigation through navigation 506. For example, menu 504 may allow a user to perform various functions, such as saving a file, opening a new window, displaying a history, and entering a URL. Navigation 506 allows for a user to navigate various pages and to select web sites for viewing. For example, navigation 506 may allow a user to see a previous page or a subsequent page relative to the present page. Preferences such as those illustrated in FIG. 5 may be set through preferences 508.

Communications 510 is the mechanism with which browser 500 receives documents and other resources from a network such as the Internet. Further, communications 510 is used to send or upload documents and resources onto a network. In the depicted example, communication 510 uses HTTP. Other protocols may be used depending on the implementation. Documents that are received by browser 500 are processed by language interpretation 512, which includes an HTML unit 514 and a JavaScript unit 516. Language interpretation 512 processes a document for presentation on graphical display 518. In particular, HTML statements are processed by HTML unit 514 for presentation while JavaScript statements are processed by JavaScript unit 516.

Graphical display 518 includes layout unit 520, rendering unit 522, and window management 524. These units are involved in presenting web pages to a user based on results from language interpretation 512.

Browser 500 is presented as an example of a browser program in which the present invention may be embodied. Browser 500 is not meant to imply architectural limitations to the present invention. Presently available browsers may include additional functions not shown or may omit functions shown in browser 500. A browser may be any application that is used to search for and display content on a distributed data processing system. Browser 500 may be implemented using known browser applications, such as Netscape Navigator™ or Microsoft Internet Explorer™. Netscape Navigator™ is available from Netscape Communications Corporation while Microsoft Internet Explorer™ is available from Microsoft Corporation.

Scalable Vector Graphics (SVG) is an emerging technology that allows complex graphical diagrams to be rendered in a web browser, such as web browser 500 in FIG. 5, and other environments, such as mobile phones and PDAs. SVG is an extensible Markup Language-based (XML) file format. SVG is supported in many drawing and graphic applications, such as the Visio™ and Adobe™ programs. While the most common way to create a SVG document is with a drawing application, SVG documents may be created using any text editor, since the SVG document is an XML-based file format. In an exemplary implementation of the present invention, keywords may be entered directly into the drawing as labels on the figure. In another exemplary implementation of the present invention, keywords may be assigned as object properties.

As the drawing applications support outputting the figures into a SVG document, the keywords are then also part of the SVG document that is used by the application. Application programs that support SVG documents running on an application server may then query for the underlying data required by the keywords and render a real-time decoration of the figure for the user.

Keywords may be determined for each application by the application programmer. Each keyword equates to one data source. Keywords may be thought of as meaning “get this info” or “call this procedure directly.”

A keyword may call up a complex procedure rather than just simply getting data. For example, the keyword could invoke a stored database procedure or the keyword could call to a Web service. Each user would create her own unique set of keywords that would be part of her custom graphical topological layout.

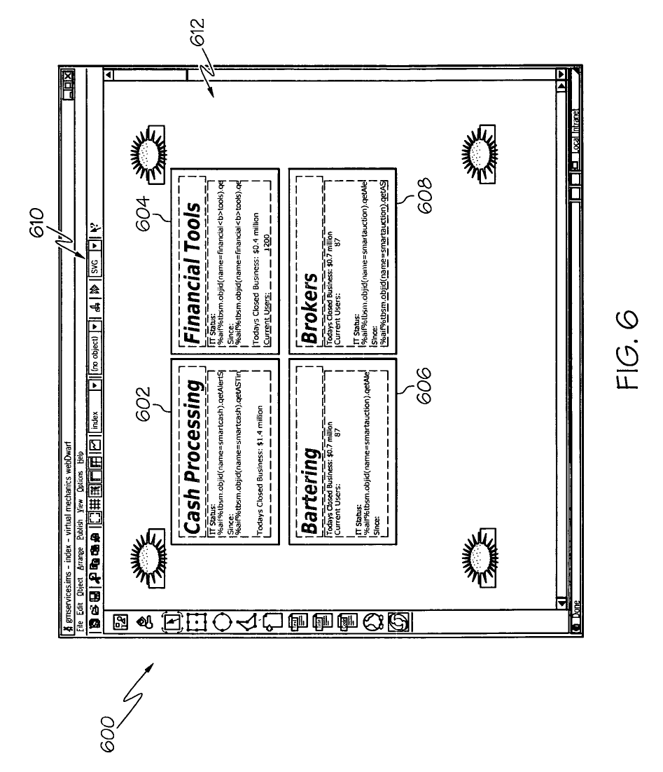

FIG. 6 is an example of a graphical topological display in accordance with an exemplary embodiment of the present invention. Application 600 is a drawing application that supports SVG as a document output format, as shown in field 610. An author uses application 600 to create graphical topological display 612. Display 612 includes four objects, 602, 604, 606, and 608. In this example, the author of display 612 would like to mix revenue data for a business service with information technology (IT) outage information. The mixing of data that resides across technical and organizational boundaries is a common requirement for these types of graphical topological displays. In each object, 602, 604, 606, and 608, static information is mixed with a script-like interface detailing the data that is desired for that location. The script-like interface is an example of a keyword. The present example shows keywords as labels, forming part of the object itself and shown in the graphical topological display itself. In another exemplary embodiment, the keywords may be stored as properties of the object and may not appear in the graphical topological display itself.

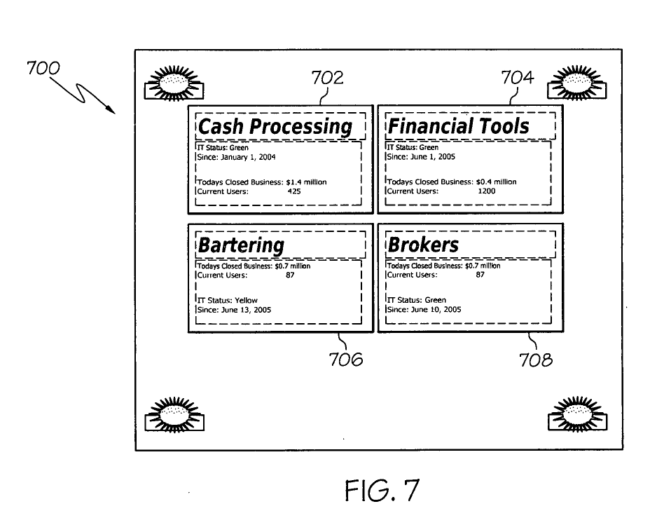

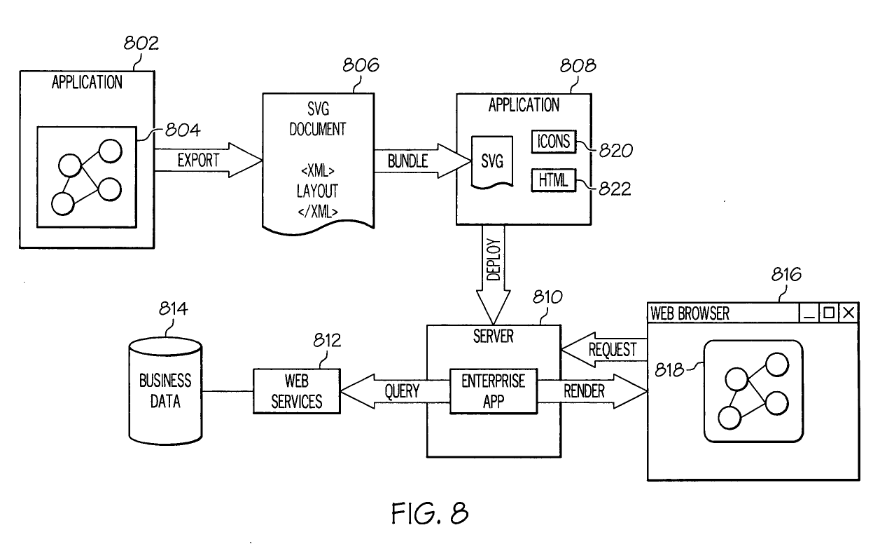

FIG. 7 is an example of a graphical topological display populated with real-time data in accordance with an exemplary embodiment of the present invention. Graphical topological display 700, is a graphical topological display such as graphical topological display 612 in FIG. 6. Graphical topological display 700 includes four objects, 702, 704, 706, and 708. Objects 702, 704, 706, and 708 are the same objects as objects 602, 604, 606, and 608 in FIG. 6. However, graphical topological display 700 shows objects 702, 704, 706, and 708 populated by the real-time data that is associated with the keywords in objects 602, 604, 606, and 608 of FIG. 6.

FIG. 8 is a block diagram illustrating a system for enabling real-time decoration for customized topology displays in accordance with an exemplary embodiment of the present invention. Drawing application 802 could be any type of drawing application, such as such as the Visio™ or Adobe™ program, for example. The user creates drawing 804, which may be, for example, a customized topological display for the resources the user wishes to monitor. Drawing 804 may be implemented as drawing 600 of FIG. 6, for example. Drawing 804 contains the keywords used to gather real-time data for drawing 804. Drawing application 802 supports the SVG format as an output form.

The user exports drawing 804 as SVG document 806 to application 808. SVG document 806 includes layout data, in an XML format, for drawing 804. SVG document 806 also includes the keywords included in drawing 804. SVG document 806 is bundled together with other supporting files, or “peers,” such as HTML 822 and icons 820 into application 808. Application 808 is deployed onto application server 810. Application 808, which could be implemented as application 410 in FIG. 4, for example, could be any kind of application, such as an enterprise application. When application 808 is running on application server 810, application 808 queries web services 812 for the underlying data associated with the keywords included in SVG document 806, in response to a request from web browser 816. Web services 812 communicate with business data 814 and return the information to application 808.

Application 808 returns a document for presentation in Web browser 816, generating a graphical topological layout 818 populated with real-time data. While the document returned by application 808 may be a document in SVG format, one of ordinary skill in the art will realize that the document may also be in a HTML format or any other format suitable for reproduction in Web browser 816. Web browser 816 resides in a client data processing system, such as data processing system 300 in FIG. 3, for example, whereas application 808 and server 810 reside in a host data processing system, such as data processing system 200 in FIG. 2, for example.

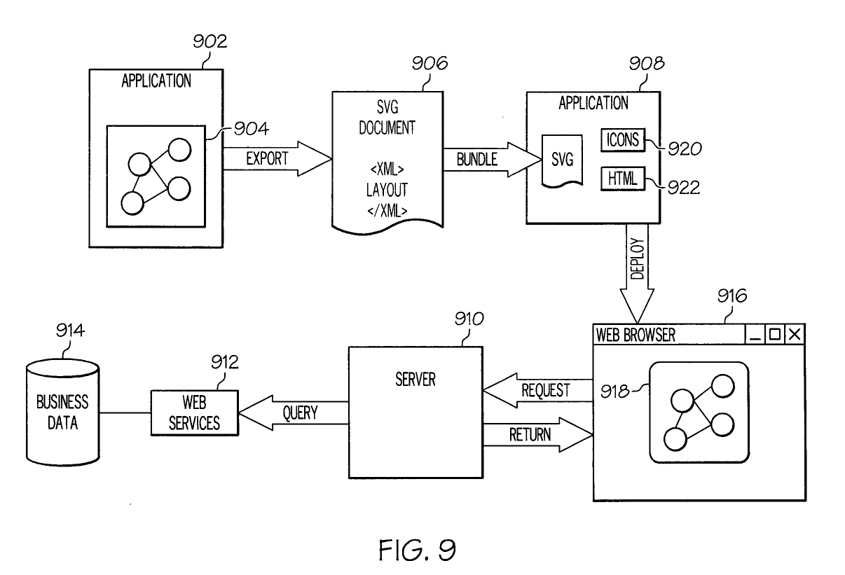

FIG. 9 is a block diagram illustrating a system for enabling real-time decoration for customized topology displays in accordance with an exemplary embodiment of the present invention. Drawing application 902 could be any type of drawing application, such as such as the Visio™ or Adobe™ program, for example. The user creates drawing 904, which is a customized topological display for the resources the user wishes to monitor. Drawing 904 may be implemented as drawing 600 of FIG. 6, for example. Drawing 904 contains the keywords used to gather real-time data for drawing 904. Drawing application 902 supports the SVG format as an output form.

The user exports drawing 904 as SVG document 906 to application 908. Application 908 resides in a client data processing system, such as data processing system 300 in FIG. 3, for example. SVG document 906 includes layout data, in an XML format, for drawing 904. SVG document 906 also includes the keywords included in drawing 904. SVG document 906 is bundled together with other supporting files, or “peers,” such as HTML 922 and icons 920 into application 908. Application 908, which could be implemented as application 410 in FIG. 4, for example, could be any kind of application, such as an enterprise application.

When application 908 is running, application 908 is deployed into web browser 916, which also resides on the client side data processing system. Web browser 916 sends a request for the underlying data associated with keywords included in SVG document 906 to server 910. Server 910 resides in a host data processing system, such as data processing system 200 in FIG. 2, for example. Server 910, queries web services 912 for the desired data. Web services 912 communicates with business data 914 and returns the desired data to server 910. Application 908 provides a document for presentation in Web browser 916, generating a graphical topological layout 918 populated with real-time data. While the document provided by application 908 may be a document in SVG format, one of ordinary skill in the art will realize that the document may also be in a HTML format or any other format suitable for reproduction in Web browser 916.

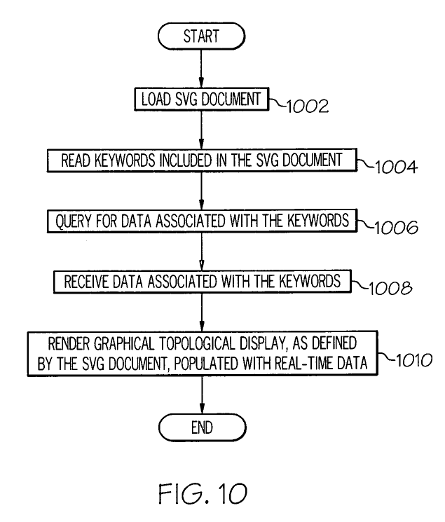

FIG. 10 is a flowchart illustrating the real-time decoration of a customized graphical topological display in accordance with an exemplary embodiment of the present invention. The real-time decoration of a customized topology display begins when the application, such as application 808 in FIG. 8, loads a document (step 1002). The application reads the keywords included in the document (step 1004). The application queries for the data associated with the keywords (step 1006). The application receives the data associated with the keywords (step 1008). The application then renders a graphical topological display, as defined by the document, populated with real-time data (step 1010). The operation then ends.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for enabling real-time decoration of graphical topological displays, the computer implemented method comprising:
loading a document, wherein the document includes layout information for a graphical topological display and wherein the document includes one or more keywords;
retrieving real-time data associated with each keyword included in the document; and
responsive to receiving the data associated with each keyword included in the document, generating the graphical topological display, as defined by the document, populated with the real-time data.

2. The computer implemented method of claim 1, wherein the document is a document in scalable vector graphics format.

3. The computer implemented method of claim 2, wherein the graphical topological display is a drawing exported from a drawing application that supports exporting files in scalable vector graphics format.

4. The computer implemented method of claim 3, wherein the one or more keywords are added to the document after the drawing was exported.

5. The computer implemented method of claim 1, wherein the one or more keywords are properties of objects in the graphical topological display.

6. The computer implemented method of claim 1, wherein the one or more keywords are labels included in the graphical topological display.

7. The computer implemented method of claim 1, wherein an application server performs the loading, retrieving, and generating steps.

8. The computer implemented method of claim 1, wherein a browser program on a client data processing system performs the loading, retrieving, and generating steps.

9. A computer program product comprising
a computer usable medium having computer usable program code for enabling real-time decoration of graphical topological displays, said computer usable program code comprising:
computer usable program code for loading a document, wherein the document includes layout information for a graphical topological display and wherein the document includes one or more keywords;
computer usable program code for retrieving real-time data associated with each keyword included in the document; and
computer usable program code, responsive to receiving the data associated with each keyword included in the document, for generating the graphical topological display, as defined by the document, populated with real-time data.

10. The computer program product of claim 9, wherein the document is a document in scalable vector graphics format.

11. The computer program product of claim 10, wherein the graphical topological display is a drawing exported from a drawing application that supports exporting files in scalable vector graphics format.

12. The computer program product of claim 11, wherein the one or more keywords are added to the document after the drawing was exported.

13. The computer program product of claim 9, wherein the one or more keywords are properties of objects in the graphical topological display.

14. The computer program product of claim 9, wherein the one or more keywords are labels included in the graphical topological display.

15. The computer program product of claim 9, wherein the computer useable program code for loading, the computer useable program code for retrieving, and the computer useable program code for generating are implemented in an application server.

16. The computer program product of claim 9, wherein the computer useable program code for loading, the computer useable program code for retrieving, and the computer useable program code for generating are implemented in a browser program on a client data processing system.

17. A data processing system for enabling real-time decoration of graphical topological displays, the data processing system comprising:
a storage device, wherein the storage device stores instructions; and
a processor, wherein the processor is configured to execute instructions to load a document, wherein the document includes layout information for a graphical topological display and wherein the document includes one or more keywords, retrieve real-time data associated with each keyword included in the document, and responsive to receiving the data associated with each keyword included in the document, generate the graphical topological display, as defined by the document, populated with real-time data.

18. The data processing system of claim 17, wherein the document is a document in scalable vector graphics format.

19. The data processing system of claim 18, wherein the graphical topological display is a drawing exported from a drawing application that supports exporting files in scalable vector graphics format.

20. The data processing system of claim 15, wherein the one or more keywords are labels included in the graphical topological display.
